(19) United States
(12) Patent Application Publication
(10) Pub. No.: US 2019/0278035 A1
(43) Pub. Date: Sep. 12, 2019

(54) STACKED TRANSCEIVER ARCHITECTURE

(71) Applicant: Kaiam Corp., Newark, CA (US)

(72) Inventors: Bardia Pezeshki, Menlo Park, CA (US); Hendrick Bulthuis, Newark, CA (US); Ramsey Selim, Edinburgh (GB); Andrew Grant, Linlithgow Bridge (GB); Lucas Soldano, Milan (IT); Owen Shea, Edinburgh (GB); Josef Wendland, Newark, CA (US); Jamie Stokes, Linlithgow (GB); Suresh Rangarajan, Pleasanton, CA (US); Josh Oen, Newark, CA (US); Ron Zhang, Newark, CA (US); Rob Kalman, Newark, CA (US); Drew Lundsten, Newark, CA (US)

(21) Appl. No.: 16/298,850

(22) Filed: Mar. 11, 2019

Related U.S. Application Data
(60) Provisional application No. 62/640,756, filed on Mar. 9, 2018.

(51) Int. Cl. G02B 6/42; H04B 10/40

(52) U.S. Cl. CPC G02B 6/4246; G02B 6/4281; H04B 10/40; G02B 6/4279; G02B 6/4278; G02B 6/4273

(57) ABSTRACT

An optical transceiver may include a circuit board, lasers, and a PLC including optical multiplexers and demultiplexers. The PLC may be coupled to fiber optic lines at a forward edge of the PLC, with a rear edge of the PLC receiving light for transmission generated by the lasers. Light received at the forward edge of the PLC may be demultiplexed into data channels and routed to a top surface of the PLC for optoelectronic conversion by photodetectors. In some embodiments each data channel is routed into a corresponding plurality of waveguides, with each of the corresponding plurality of waveguides providing light to the same photodetector. In some embodiments at least some receive side electronic circuitry, other than photodetectors, is stacked on top of the PLC.

### CROSS REFERENCE TO RELATED APPLICATION

This application claims the benefit of the filing date of U.S. Provisional Patent Application No. 62/640,756, filed on Mar. 9, 2018, the disclosure of which is incorporated by reference herein.

### BACKGROUND OF THE INVENTION

The present invention relates generally to optical communications, and more particularly to an optical transceiver.

Optical transceivers are generally used in optical data communications applications. These transceivers generally transmit data over one or more fiber optic lines, and receive data over one or more other fiber optic lines. The data may be transmitted and received over a plurality of wavelengths, with for example a channel of data at each wavelength.

Optical transceivers are used in transmitting and receiving data in optical form. Optical transceivers generally perform electro-optical conversion of data to be transmitted over an optical channel, and similarly generally perform optical-electrical conversion of data received over an optical channel. Operationally, optical transceivers generally should do so reliably and at very high data rates.

Increasing data bandwidth often poses difficulties. Data bandwidth may be increased by some or all of increasing transmission speed, increasing numbers of transmitted channels, and increasing numbers of bits per transmitted symbol.

Increasing transmission speed is often non-trivial. Desired increases in transmission speeds may be above the effective clock rates of electronic circuitry processing information to be transmitted over a channel and information received over the channel. Clocking electronic circuitry at higher clock rates may also result in issues relating to thermal loads generated by the electronic circuitry and/or optical circuitry. In addition, signal noise considerations, whether in the electronic or optical domain, may become increasingly difficult to resolve at increased transmission speeds.

Increasing numbers of channels of data also presents multiple problems. Optical hardware in many instances faces space constraints, and there may be simply insufficient space for hardware items necessary for an increased number of channels. In addition, additional hardware, whether electrical or optical, may result in thermal issues relating to the use of the additional hardware.

Increasing numbers of bits per transmitted symbol can also pose difficulties. For example, various modulation schemes may be used to increase a number of bits per symbol transmitted over a channel. Those modulation schemes, however, may increase susceptibility to noise. Moreover, the susceptibility to noise may increase at a rate greater than the increase in data bandwidth.

### BRIEF SUMMARY OF THE INVENTION

Some embodiments provide an optical transceiver with an increased number of available channels. In some embodiments heat generating portions of the optical transceiver are separated in space within a housing of the optical transceiver.

In some embodiments an optical transceiver includes at least some receive side opto-electronic conversion components and receive side integrated circuit components mounted along a length of a planar lightwave circuit (PLC) and at least some transmit side electro-optical conversion components mounted about a first end of the length of the PLC. In some embodiments receive side opto-electronic conversion components comprise photodetectors and the receive side integrated circuit components comprise transimpedance amplifiers (TIAs). In some embodiments the transmit side electro-optical conversion components comprise lasers. In some embodiments a circuit board including further receive side integrated circuit components is mounted on the PLC, in some embodiments on the PLC about the first end of the length of the PLC. In some embodiments a flexible cable is used to interconnect the receive side integrated circuit components and the further receive side integrated circuit components. In some embodiments a flexible circuit is so used. In some embodiments a radio frequency (RF) bridge is so used. In some embodiments a flexible printed circuit board is so used. In some embodiments a rigid printed circuit board is so used. In some embodiments a ceramic carrier is so used. In some embodiments the PLC includes first light ports for receiving light from the lasers on the first side, and second light ports for coupling to fiber optic lines on a second side of the length opposite the first side, and third light ports along the length. In some embodiments the second light ports are coupled to the first light ports by optical multiplexers, and the third light ports are coupled to the second light ports by optical demultiplexers. In some embodiments the optical demultiplexers are configured to split each of a plurality of received optical channels into a plurality of waveguides, with the plurality of each of the received optical channels coupled to corresponding ones of the photodetectors. In some embodiments the plurality of waveguides are single mode waveguides. In some embodiments the optical transceiver includes 8 lasers, and the optical demultiplexers split each of the plurality of received optical channels into a plurality of waveguides. In some embodiments the plurality of waveguides are single mode waveguides. In some embodiments the plurality of waveguides comprise at least 4 waveguides. In some embodiments the plurality of waveguides comprise 5 waveguides.

In some embodiments an optical transceiver includes a plurality of lasers, a planar lightwave circuit (PLC) coupling light from the lasers to at least one first optical fiber and coupling light from at least one second optical fiber to a plurality of photodetectors on a wavelength selective basis such that light at each of a plurality of particular wavelengths is coupled to each of a corresponding plurality of waveguides, with each of the corresponding plurality of waveguides coupled to each of corresponding ones of the plurality of photodetectors. In some embodiments the photodetectors are mounted on top of the PLC. In some embodiments the PLC includes turning minors in each of the corresponding plurality of waveguides to reflect light towards the photodetectors.

Some embodiments provide an optical transceiver, comprising: a plurality of lasers; a planar lightwave circuit (PLC) including first ports on a first side of the PLC configured to receive light from the lasers and to multiplex the light from the lasers into a least one optical output on a second side of the PLC, the PLC further including optical inputs on the second side of the PLC, the PLC being further configured to route input light from the optical inputs to first positions of a top surface of the PLC, the first positions of the top surface being closer to the second side of the PLC than the first side of the PLC; receive side circuitry on the top surface of the PLC, at least some of the receive side circuitry mounted to the top surface of the PLC at the first positions of the top surface of the PLC; a circuit board positioned about the first side of the PLC, the circuit board including circuitry for driving the lasers and at least some further receive side circuitry; and an electrical connection between the receive side circuitry and the further receive side circuitry.

Some embodiments provide an optical transceiver, comprising: a plurality of lasers; a plurality of photodetectors; a planar lightwave circuit (PLC) coupling light from the lasers to at least one first optical fiber and coupling light from at least one second optical fiber to the plurality of photodetectors on a wavelength selective basis, such that light at each of a plurality of particular wavelengths is coupled to each of a corresponding plurality of waveguides, with each of the corresponding plurality of waveguides coupled to each of corresponding ones of the plurality of photodetectors; wherein the lasers are mounted about a first side of the PLC; wherein the photodetectors are on top of the PLC, closer to a second side of the PLC than the first side of the PLC; a circuit board including electrical circuitry for driving the lasers, the circuit board positioned about the first side of the PLC; and a flexible connection electrically coupling the photodetectors and the circuit board.

These and other aspects of the invention are more fully comprehended upon review of this disclosure.

### BRIEF DESCRIPTION OF THE FIGURES

FIG. 1 is a perspective view of an optical transceiver in a housing, in accordance with aspects of the invention.

FIG. 2 is a semi-block diagram perspective view of a further embodiment of an optical transceiver in accordance with aspects of the invention.

FIG. 3 is a top view of the optical transceiver of FIG. 1.

FIG. 4 is a partial top view showing a planar lightwave circuit (PLC) and other components of the optical transceiver of FIG. 1.

FIG. 5 is a top view of lasers and MEMS coupling devices for an optical transceiver in accordance with aspects of the invention.

FIG. 6 is a top view showing transimpedance amplifier (TIA) chips and photodetectors mounted on a PLC in accordance with aspects of the invention.

FIG. 7 is a top view showing a PLC layout in accordance with aspects of the invention.

FIG. 8 illustrates the use of multiple waveguides for providing light to a single photodetector, in accordance with aspects of the invention.

FIG. 9 illustrates an output of a demultiplexer of the PLC of FIG. 7.

FIG. 10 illustrates a configuration for receiver stacking for an optical transceiver, in accordance with aspects of the invention.

FIG. 11 illustrates a further configuration for receiver stacking for an optical transceiver, in accordance with aspects of the invention.

### DETAILED DESCRIPTION

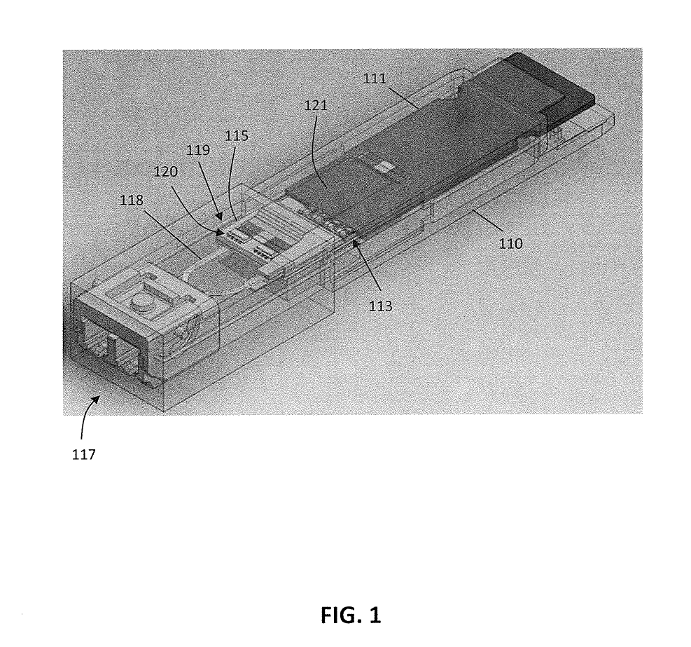

FIG. 1 is a perspective view of an optical transceiver in a housing 110, in accordance with aspects of the invention. The housing is illustrated in ghosted form, in order to more fully illustrate components of the transceiver. The housing shown is a Quad Small Form Pluggable (QSFP) type housing. In various embodiments the housing may be of a small form factor pluggable (SFP) type, or a variant of an SFP type, or some other pluggable type. In many instances, the housing is mounted in a switch, for example of a data center, along with many additional optical transceivers in similar housings.

The optical transceiver includes a printed circuit board 111 towards a rear of the housing. The printed circuit board includes, for example, semiconductor chips (not shown) for driving lasers with data to be transmitted, and semiconductor chips (not shown) for performing clock and data recovery functions for received data. In some embodiments the semiconductor chips for driving lasers and the semiconductor chips for performing clock and data recovery (CDR) functions may be combined, either in a same chip or a same chip package.

Lasers 113 are forward of the semiconductor chips on the printed circuit board. In some embodiments the lasers are electro-absorption modulated lasers (EMLs). In some embodiments the lasers are directly modulated lasers (DMLs). In some embodiments lasers and modulation devices, for example Mach-Zehnder modulators, are provided separately. In some embodiments the lasers are on a submount mounted to the printed circuit board. In some embodiments the lasers are mounted on a submount at a forward edge of the printed circuit board. In some embodiments, including the embodiment of FIG. 1, there are eight lasers, with, for example, two lasers on each of four laser submounts.

A planar lightwave circuit (PLC) 119 is forward of the lasers. The PLC is positioned so as to receive light from the lasers in ports on a rearward edge of the PLC. In some embodiments optical adjustment elements may be mounted with the lasers to more completely direct light from the lasers into the ports on the rearward edge of the PLC. The PLC multiplexes light from the lasers into at least one optical output on a forward edge of the PLC. In the embodiment of FIG. 1, the PLC multiplexes light from the lasers into two PLC optical outputs. The PLC therefore routes light carrying transmit data from the rearward edge to the forward edge of the PLC. The PLC optical outputs are coupled by fiber lines 118 (which may be fiber pigtails) to ports 117 of the optical transceiver housing (with the fiber lines 118 being shown as going under the PLC, the portion looping back to the ports 117 not being shown). Generally the ports of the optical transceiver housing are used for coupling of fiber optic lines for carrying optical data to other devices.

The fiber optic lines also carry data to the optical transceiver, with the fiber lines also coupling the ports 117 to optical inputs on the forward edge of the PLC. The PLC demultiplexer light from the optical inputs, generally on a wavelength selective basis, and provides the light to photodiodes 120 mounted atop the PLC. The PLC therefore routes light carrying receive data from the forward edge to a top surface of the PLC. In some embodiments the photodiodes are mounted closer to the forward edge of the PLC than the rearward edge of the PLC. In some embodiments the photodiodes are mounted approximately halfway between the forward edge and the rearward edge of the PLC. In some embodiment the photodiodes (and transimpedance amplifiers, discussed below) are mounted on the PLC a distance sufficient from the lasers that thermal effects generated by the lasers do not adversely impact operation of the photodiodes (and transimpedance amplifiers), and/or vice versa.

The photodiodes perform opto-electronic conversion of the data, with outputs of the photodiodes coupled to transimpedance amplifiers (TIAs) 119. In many embodiments, and as illustrated in FIG. 1, the transimpedance amplifiers are mounted on the PLC in close proximity to the photodiodes. Mounting the transimpedance amplifiers in close proximity to the photodiodes reduces effects of noise on generally small strength signals provided by the photodiodes.

A flex cable 121 routes signals from the TIAs to the printed circuit board, and thence to, for example, CDR chips on the printed circuit board. In some embodiments the CDR chips may be located instead with the TIA chips, with the flex cable routing signals from the CDR chips to other circuitry on the printed circuit board. In some embodiments some other flexible circuit is used in place of the flex cable. For example, in some embodiments a flexible PCB may be used. In some embodiments a non-flexible connection may be used instead of the flex cable. The flex cable may be glued to the PLC so as to couple metallized traces of the flex cable to the PLC, for example, with outputs of the TIAs wirebonded to the metallized tracks or otherwise coupled to the metallized tracks. In some embodiments metallized traces of the flex cable may also or instead be wirebonded to signal tracks printed on the PLC.

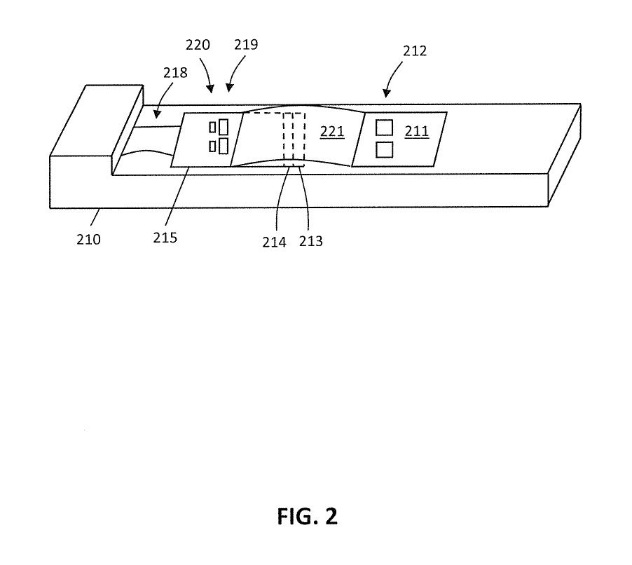

FIG. 2 is a semi-block diagram perspective view of a further embodiment of an optical transceiver in accordance with aspects of the invention. The embodiment of FIG. 2 is similar to the embodiment of FIG. 1, in that the embodiment of FIG. 2 includes a housing 210 of a pluggable form factor, and including within the housing a circuit board 211 including transmit side (e.g. laser driver) and receive side (e.g. CDR) integrated circuitry 212, lasers 213 for performing electro-optical conversion, and a PLC 215 for multiplexing light from the laser onto optical outputs. FIG. 2 additionally indicates optical adjustment elements 214, configured to focus light of the lasers into ports of the PLC. As with the embodiment of FIG. 1, the PLC is also configured for demultiplexing received light for delivery to photodiodes 220 atop the PLC, with TIAs 219 adjacent the photodiodes for amplifying signals from the photodiodes. FIG. 2 also illustrates fiber pig-tails 218 coupling optical ports on the forward edge of the PLC with output ports of the optical transceiver.

In the embodiment of FIG. 2, a flex cable 221 data couples the TIAs and the receive side integrated circuitry on the circuit board. Similar to the flex cable of FIG. 1, the flex cable of FIG. 2 passes over the lasers and a portion of the PLC.

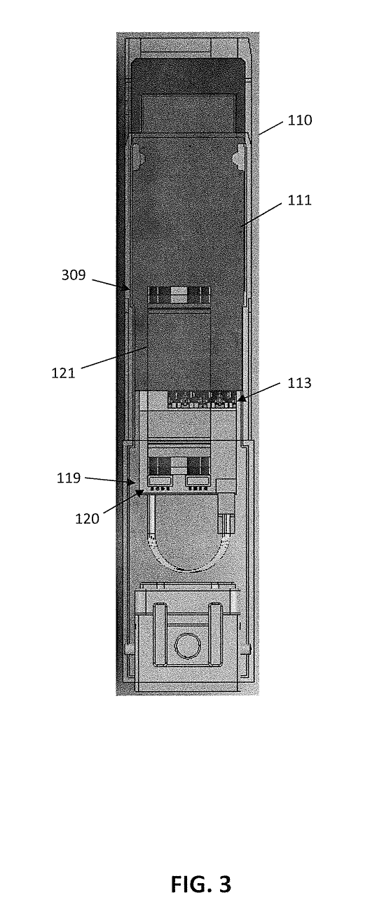

FIG. 3 is a top view of the optical transceiver of FIG. 1. FIG. 3 shows the circuit board 111 within and towards a rear of the housing 110 of the optical transceiver. The circuit board includes integrated circuit chips 309 for performing transmit side and receive side processing of data to be transmitted and of received data, respectively. The lasers 113 provide electro-optical conversion of the data to be transmitted, with light from the lasers provided to the PLC.

In the embodiment of FIG. 3, the photodiodes 120, of which there are eight for eight data channels, are towards a front edge of the PLC. The TIAs are shown as immediately behind the photodiodes.

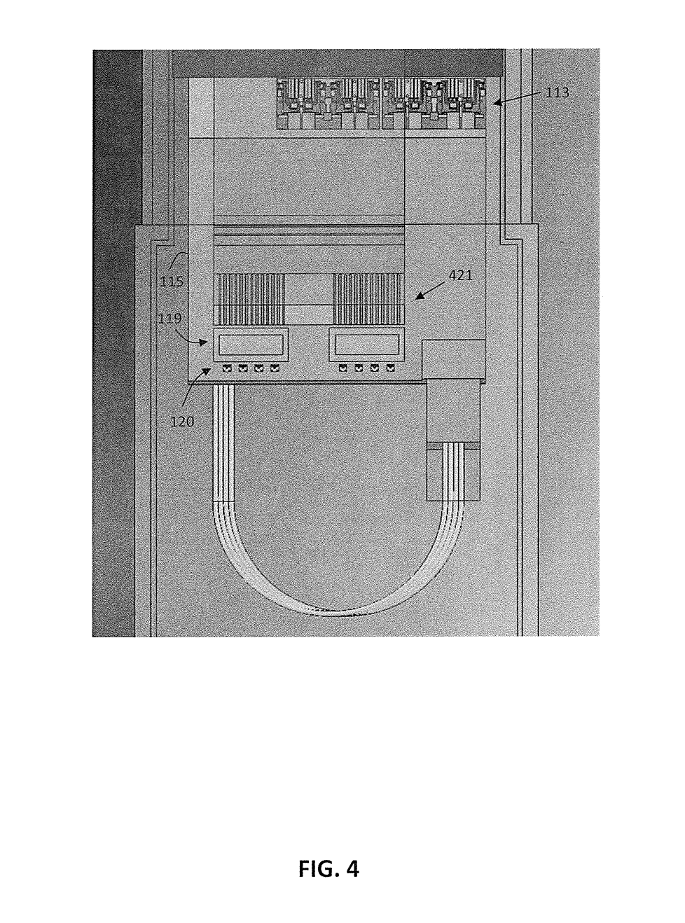

FIG. 4 is a partial top view showing the planar lightwave circuit (PLC) and other components of the optical transceiver of FIG. 1. In FIG. 4 the lasers 113 are shown along a rear edge of the PLC 115, with the lasers generally spread over a length greater than 50% of the length of the rear edge of the PLC. Eight lasers are shown, with the lasers in groups of 2.

Eight photodetectors 120 are also shown atop the PLC, about a forward edge of the PLC. In various embodiments the photodetectors may be positioned in other locations atop the PLC. Generally, however, in most embodiments the photodetectors are positioned at least atop the front two-thirds of the PLC, in some embodiments the photodetectors are positioned atop the front half of the PLC, and in some embodiments the photodetectors are positioned atop the front third of the PLC.

The TIAs 119 are also atop the PLC, generally adjacent the photodetectors. Metallized traces 421 of the flex cable extend towards the TIAs, allowing for example for wirebond connections between the TIAs and the metallized traces of the flex cable.

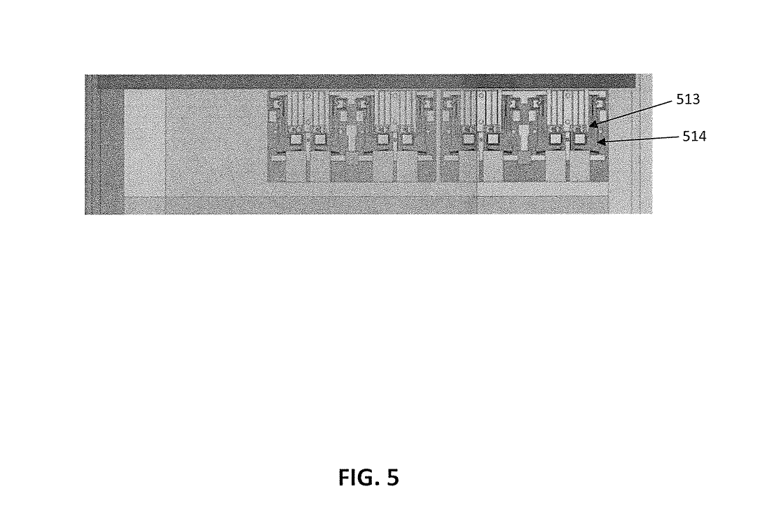

FIG. 5 is a top view of lasers and MEMS coupling devices for an optical transceiver in accordance with aspects of the invention. The lasers and MEMS coupling devices may be used in the embodiments of FIGS. 1-4. In FIG. 5, lasers 513 are provided in pairs on submounts. The lasers may be, for example, EMLs. MEMS optical coupling devices 514 include lenses between the lasers and input ports of the PLC. The MEMS optical coupling devices may be used to more fully direct light from the lasers into the input ports of the PLC. In some embodiments the MEMS coupling devices are as discussed in U.S. patent application Ser. No. 15/812,273, filed Nov. 14, 2017, entitled Transceiver High Density Module, the disclosure of which is incorporated by reference herein for all purposes.

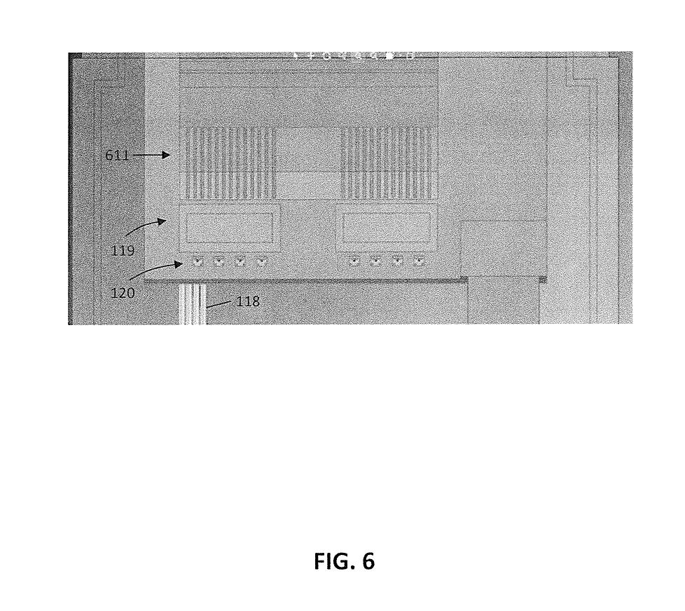

FIG. 6 is a top view showing transimpedance amplifier (TIA) chips and photodetectors mounted over a PLC in accordance with aspects of the invention. The photodetectors 120 are shown towards a front edge of the PLC, with the TIA chips 119 generally immediately behind the photodetectors. Metallized traces 611 of the flex cable extend along a top of the PLC behind the TIAs. Outputs of the TIAs are coupled to the metallized traces, for example by wirebonding.

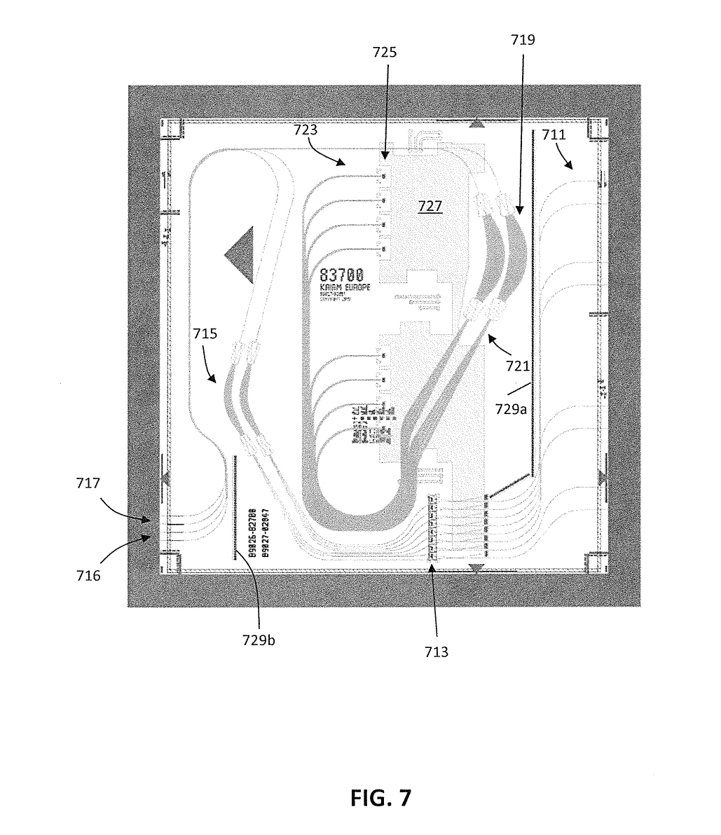

FIG. 7 is a top view showing a PLC and its layout in accordance with aspects of the invention. The PLC layout, or aspects of the PLC layout, may be used for the PLC of the optical transceivers discussed herein.

The PLC includes a plurality of ports 711 along a first edge of the PLC. In the example of FIG. 7 there are eight ports. For convenience the ports 711 will be termed transmit input ports, as the ports 711 are intended for use in receiving light from lasers intended for transmission. Also for convenience, the first edge of the PLC may be termed a rear edge of the PLC, as in most embodiments the first edge of the PLC will be positioned facing a rear of an optical transceiver.

As illustrated, the transmit input ports are generally spaced across a length of the rear edge of the PLC. Spacing across the rear edge allows for increased spatial separation of at least some of the lasers used to provide light to the PLC. In some embodiments the spacing between input ports may be uniform. In the embodiment of FIG. 7, however, the transmit input ports are generally grouped in pairs, allowing for example for the use of pairs of lasers on each laser submount.

Waveguides from the transmit input ports extend towards and alongside a lengthwise edge of the PLC, and then turn inwards towards a pair of multiplexers 715. Along the way, the waveguides pass turning mirrors, which direct a portion of the light in the waveguides upwards and out of the PLC. In most embodiments monitor photodetectors are positioned to receive the portion of the light, with the monitor photodetectors for example flip chipped on top of the PLC. The monitor photodetectors are generally used to provide feedback to laser driver circuitry for operation of the lasers.

The pair of multiplexers each multiplex light from 4 waveguides into a corresponding single output waveguide of a pair of output waveguides. The multiplexers may be, for example, arrayed waveguide gratings (AWGs), or some other optical multiplexer. The output waveguides extend to transmit output ports 716 of the PLC. The transmit output ports are on what may be considered a forward edge of the PLC, with the forward edge of the PLC being on an opposite side of the PLC than the rear edge of the PLC. The output waveguides may be coupled to a fiber pigtail or other element, for providing light to fiber optic lines coupling switches of, for example, a data center.

The PLC also has receive input ports 717 on the forward edge of the PLC. The receive input ports are coupled to waveguides that couple the receive input ports to a pair of demultiplexers 719. The demultiplexers may be, for example AWGs or some other optical demultiplexer. In the embodiment of FIG. 7, each of the demultiplexers split light from the receive input ports into 4 channels on a wavelength selective basis. In some embodiments light of the 4 channels is provided to four waveguides, for example multimode waveguides, with each of the waveguides receiving light for a corresponding one of the 4 channels. In the embodiment of FIG. 7, however, the demultiplexers provide the light for each channel into a plurality of waveguides, 5 waveguides in the example of FIG. 7, of a total of 40 waveguides, such that each demultiplexer may be considered a 1:20 demultiplexer. In some embodiments the plurality of waveguides, 5 waveguides in the example of FIG. 7, are single mode waveguides, or at least single mode in one dimension. The use of single mode waveguides may be beneficial, for example, in allowing for increased bend radius of the waveguides, thereby allowing for decreased footprint size of the PLC.

For each channel output of the demultiplexers, the 5 waveguides are each routed to one of 8 turning mirrors 725 in the PLC. The turning mirrors direct light upward and out of a top surface of the PLC. In most embodiments photodetectors are flip chip mounted atop the PLC to receive the light, with each photodetector receiving light provided by 5 waveguides. The use of the plurality of waveguides, 5 waveguides in the example of FIG. 7, may allow for increased tolerances in positioning of the photodetectors on the PLC. In addition, the embodiment of FIG. 7 includes isolation trenches 729a,b or other optical isolation structures, positioned between the ports on the rear and forward edges of the PLC and the AWGs of the PLC. The isolation trenches help isolate the AWGs, and photodetectors, from stray light.

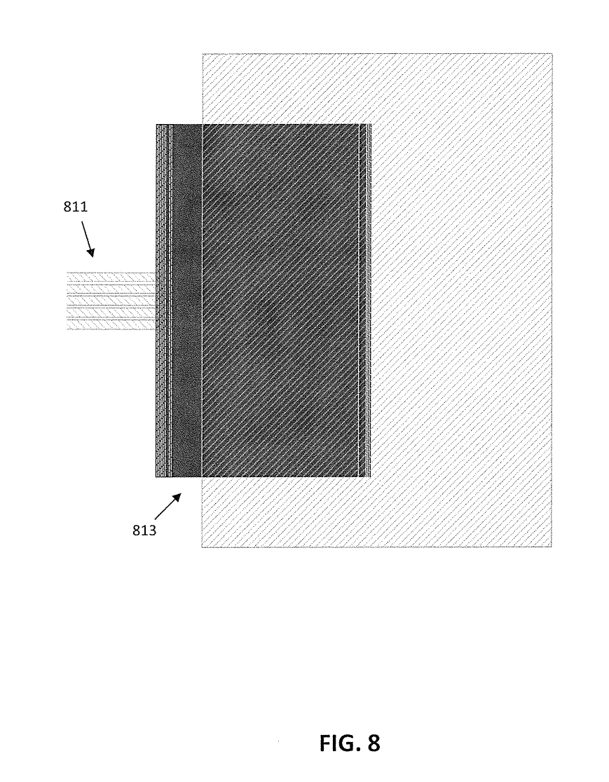

FIG. 8 illustrates the use of multiple waveguides for providing light to a single photodetector, in accordance with aspects of the invention. The waveguides may be one set of the 5 waveguides discussed with respect to the embodiment of FIG. 7. In FIG. 8 a plurality of waveguides, 5 as illustrated in FIG. 8, provide light of a single received channel. The waveguides are routed to a turning mirror 813, which directs light out of the PLC. In most embodiments a photodetector is positioned to receive the light exiting the PLC.

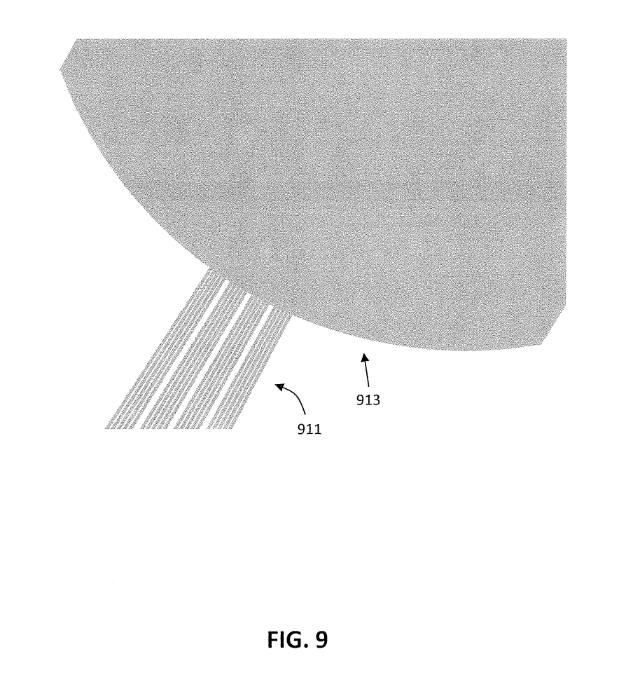

FIG. 9 illustrates outputs 911 of a demultiplexer of the PLC of FIG. 7. The outputs include 4 data channels, with each of the channels being light about a particular wavelength. Each of the channels is also split into 5 different waveguides, for a total of 20 output waveguides. Splitting of each channel into a plurality of waveguides may be beneficial, for example by allowing for a tighter bend radius for waveguides on the PLC, and hence a smaller PLC footprint.

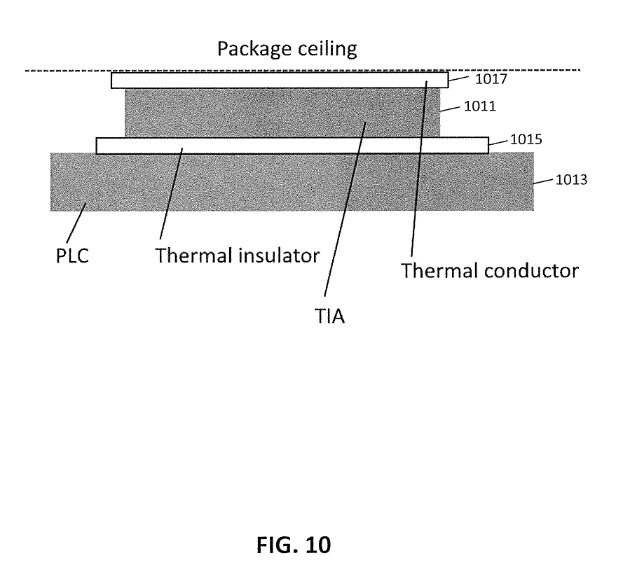

FIG. 10 illustrates a configuration for receiver stacking for an optical transceiver, in accordance with aspects of the invention. In the embodiment of FIG. 10, a TIA 1011 is mounted on top of a PLC 1013. A thermal insulator 1015 is between the TIA and the PLC. A thermal conductor 1017 is over the TIA. The use of the thermal insulator and/or thermal conductor assists in directing heat away from the PLC and out of the package.

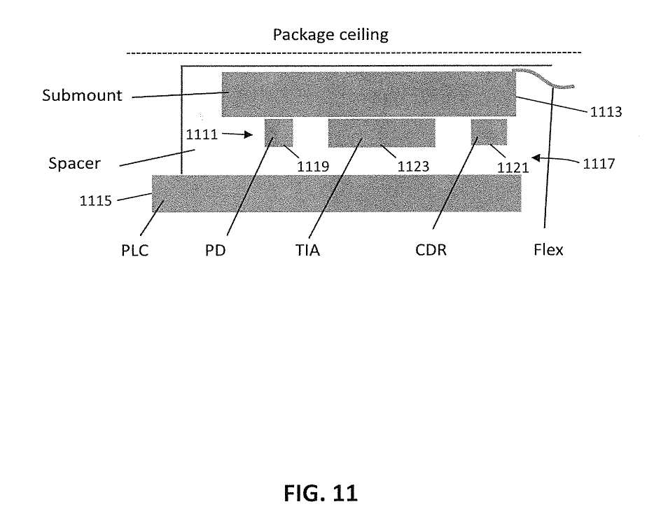

FIG. 11 illustrates a further configuration for receiver stacking for an optical transceiver, in accordance with aspects of the invention. In the embodiment of FIG. 11, receive side electronics 1111 are mounted to a submount 1113. The submount in turn is mounted to a PLC 1115. In some embodiments the submount is directly attached atop the PLC. In the embodiment of FIG. 11, however, the submount is attached to the PLC via a spacer 1117. In some embodiments the photodetectors 1119 are mounted on the submount as illustrated, facing the PLC, with some or all of the other electrical/electronic components mounted on the other side of the submount. In addition, FIG. 11 shows a CDR chip 1121 mounted near TIAs 1123.

Although the invention has been discussed with respect to various embodiments, it should be recognized that the invention comprises the novel and non-obvious claims supported by this disclosure.

What is claimed is:

1. An optical transceiver, comprising:
a plurality of lasers;
a planar lightwave circuit (PLC) including first ports on a first side of the PLC configured to receive light from the lasers and to multiplex the light from the lasers into a least one optical output on a second side of the PLC, the PLC further including optical inputs on the second side of the PLC, the PLC being further configured to route input light from the optical inputs to first positions of a top surface of the PLC, the first positions of the top surface being closer to the second side of the PLC than the first side of the PLC;
receive side circuitry on the top surface of the PLC, at least some of the receive side circuitry mounted to the top surface of the PLC at the first positions of the top surface of the PLC;
a circuit board positioned about the first side of the PLC, the circuit board including circuitry for driving the lasers and at least some further receive side circuitry; and
an electrical connection between the receive side circuitry and the further receive side circuitry.

2. The optical transceiver of claim 1, wherein the receive side circuitry comprises photodiodes and transimpedance amplifiers.

3. The optical transceiver of claim 2, further comprising a thermal insulator between the transimpedance amplifiers and the PLC.

4. The optical transceiver of claim 2, further comprising a spacer between the transimpedance amplifiers and the PLC.

5. The optical transceiver of claim 2, further comprising a submount, and wherein the receive side circuitry is mounted to the submount, with the photodiodes facing the PLC.

6. The optical transceiver of claim 2, further comprising a thermal conductor over the transimpedance amplifiers.

7. The optical transceiver of claim 2, wherein the further receive side circuitry comprises clock and data recovery circuitry.

8. The optical transceiver of claim 1, wherein the lasers are positioned about the first side of the PLC.

9. The optical transceiver of claim 8, wherein the lasers are positioned to be spread over a length greater than half of a length of the first side of the PLC.

10. The optical transceiver of claim 1, wherein the electrical connection comprises a flex cable.

11. The optical transceiver of claim 10, wherein the flex cable is glued to the PLC.

12. The optical transceiver of claim 1, wherein the electrical connection comprises a flexible circuit board.

13. The optical transceiver of claim 1, wherein the electrical connection comprises an RF bridge.

14. The optical transceiver of claim 1, wherein the PLC includes optical demultiplexers in the routing for the light from the optical inputs to the first positions of the tope surface of the PLC, the optical demultiplexers configured to split the input light into a plurality of waveguides, and wherein the plurality of waveguides are single mode waveguides.

15. The optical transceiver of claim 1, wherein the first positions are at least twice as close to the second side of the PLC than the first side of the PLC.

16. The optical transceiver of claim 1, wherein the first positions are about the second side of the PLC.

17. An optical transceiver, comprising:
a plurality of lasers;
a plurality of photodetectors;
a planar lightwave circuit (PLC) coupling light from the lasers to at least one first optical fiber and coupling light from at least one second optical fiber to the plurality of photodetectors on a wavelength selective basis, such that light at each of a plurality of particular wavelengths is coupled to each of a corresponding plurality of waveguides, with each of the corresponding plurality of waveguides coupled to each of corresponding ones of the plurality of photodetectors;
wherein the lasers are mounted about a first side of the PLC;
wherein the photodetectors are on top of the PLC, closer to a second side of the PLC than the first side of the PLC;
a circuit board including electrical circuitry for driving the lasers, the circuit board positioned about the first side of the PLC; and
a flexible connection electrically coupling the photodetectors and the circuit board.

18. The optical transceiver of claim 17, further comprising transimpedance amplifiers on top of the PLC, closer to the second side of the PLC than the first side, the transimpedance amplifiers coupled to the photodetectors.

19. The optical transceiver of claim 18, wherein the flexible connection electrically couples the transimpedance amplifiers and the circuit board.

20. The optical transceiver of claim 19, wherein the flexible connection comprises a flex cable.
